(19) United States
(12) Patent Application Publication
(10) Pub. No.: US 2020/0336036 A1
(43) Pub. Date: Oct. 22, 2020

(54) ROTARY ACTUATOR AND METHOD FOR MANUFACTURING THE SAME

(71) Applicant: DENSO CORPORATION, Kariya-city (JP)

(72) Inventors: Yuriko KATO, Kariya-city (JP); Mikine KUME, Kariya-city (JP); Hiroyuki KADO, Kariya-city (JP)

(21) Appl. No.: 16/847,820

(22) Filed: Apr. 14, 2020

(30) Foreign Application Priority Data
Apr. 16, 2019 (JP) 2019-077983

(51) Int. Cl. H02K 3/52; H02K 7/116; H02K 11/33; H02K 15/00; F16H 61/32

(52) U.S. Cl. CPC H02K 3/522; H02K 7/116; H02K 11/33; F16H 2061/326; F16H 61/32; H02K 2203/09; H02K 2211/03; H02K 15/0062

(57) ABSTRACT

A rotary actuator is used in a shift-by-wire system for a vehicle. The actuator includes a motor, a controller, a housing, and a terminal. The controller controls the motor. The housing holds a stator of the motor and the controller. The terminal electrically connects a coil of the stator to the controller. The terminal includes a fused portion electrically connected to the coil. The fused portion is compressed in a direction in parallel with an axial direction of the motor.

### CROSS REFERENCE TO RELATED APPLICATIONS

This application is based on Japanese Patent Application No. 2019-077983 filed on Apr. 16, 2019, all of which is incorporated herein by reference.

### TECHNICAL FIELD

The present disclosure relates to a rotary actuator and a method for manufacturing the rotary actuator.

### BACKGROUND

There has been known an electromechanical integrated rotary actuator in which an operating unit with a motor and a controller for controlling the motor are integrally formed. For example, a coil of a stator of a motor is electrically connected to a controller via a terminal attached to a bobbin. The end of the coil is electrically connected to the terminal by fusing (welding).

### SUMMARY

One aspect of the present disclosure is a rotary actuator used in a shift-by-wire system for a vehicle. The actuator includes a motor, a controller that controls the motor, a housing that holds a stator of the motor and the controller, and a terminal that electrically connects a coil of the stator to the controller. The terminal includes a fused portion electrically connected to the coil. The fused portion is compressed in a direction in parallel with an axial direction of the motor.

### BRIEF DESCRIPTION OF THE DRAWINGS

FIG. 1 is a schematic diagram showing a shift-by-wire system to which a rotary actuator according to a first embodiment is applied.

FIG. 2 is a diagram illustrating a shift range switching mechanism of FIG. 1.

FIG. 3 is a cross-sectional view of the rotary actuator according to the first embodiment.

FIG. 4 is an enlarged view of IV part in FIG. 3.

FIG. 5 is a view of the stator and a bus bar of FIG. 3 viewed in a V direction.

FIG. 6 is a sectional view of the stator and the bus bar taken along VI-VI line of FIG. 5.

FIG. 7 is a diagram showing the bus bar of FIG. 5.

FIG. 8 is a diagram for explaining a fusing step of connecting the terminal and the coil of FIG. 3.

FIG. 9 is a sectional view of a stator and a bus bar of the rotary actuator according to a second embodiment, which corresponds to FIG. 6 in the first embodiment.

FIG. 10 is a front view showing an upper case and terminals of a rotary actuator according to a third embodiment.

FIG. 11A is a diagram illustrating a state prior to a fusing step of a rotary actuator according to a fourth embodiment where a fused portion viewed in an axial direction

FIG. 11B is a diagram illustrating a state prior to the fusing step of the rotary actuator according to the fourth embodiment where the fused portion is viewed in a radial direction.

FIG. 12A is a diagram illustrating the fusing step of the rotary actuator according to the fourth embodiment where the fused portion is viewed in the axial direction.

FIG. 12B is a diagram illustrating the fusing step of the rotary actuator according to the fourth embodiment where the fused portion is viewed in the radial direction.

FIG. 13A is a diagram illustrating a bending step of the rotary actuator according to the fourth embodiment where the fused portion is viewed in the axial direction.

FIG. 13B is a diagram illustrating the bending step of the rotary actuator according to the fourth embodiment where the fused portion is viewed in the radial direction.

FIG. 14A is a diagram illustrating the bending step of the rotary actuator according to the fourth embodiment where the fused portion is viewed in the axial direction.

FIG. 14B is a diagram illustrating the bending step of the rotary actuator according to the fourth embodiment where the fused portion is viewed in the radial direction.

FIG. 15 is a front view of a motor and a bus bar of a rotary actuator according to a comparative example, which corresponds to the view of FIG. 5.

FIG. 16 is a sectional view of the stator and the bus bar taken along XVI-XVI line in FIG. 15, which corresponds to the view of FIG. 6.

FIG. 17 is a diagram comparing a thickness of the stator and the bus bar between the first embodiment and the comparative example.

### DETAILED DESCRIPTION

Hereinafter, a plurality of embodiments of a rotary actuator (hereinafter, referred to as an “actuator”) will be described with reference to the drawings. In the embodiments, substantially the same components are denoted by the same reference numerals and description thereof is omitted.

To begin with, the relevant technologies will be described only for easy understanding of the following embodiments. In a manufacturing process of a rotary actuator, fusing of the terminal is performed by pressing the terminal in a radial direction of the motor. Therefore, the total thickness along the axial direction of the stator and the fused portion of the terminal is increased, and thus the size of the rotary actuator in the axial direction is increased.

The present disclosure has been provided in view of the above, and an example of a rotary actuator that has a reduced thickness will be described below as an embodiment.

As described above, one aspect of the present disclosure is a rotary actuator used in a shift-by-wire system for a vehicle. The actuator includes a motor, a controller that controls the motor, a housing that holds a stator of the motor and the controller, and a terminal that electrically connects a coil of the stator to the controller. The terminal includes a fused portion electrically connected to the coil. The fused portion is compressed in a direction in parallel with an axial direction of the motor.

By having the compressed direction of the fused portion in parallel with the axial direction of the motor, the total thickness along the axial direction of the stator and the fused portion of the terminal can be reduced by the compressed amount of the fused portions in the axial direction by fusing. Therefore, the size of the rotary actuator can be reduced in the axial direction by arranging a component adjacent to the fused portion at a position close to the motor.

### First Embodiment

In this embodiment, an actuator is used as a driver of a shift-by-wire system for a vehicle.

### (Shift-by-Wire System)

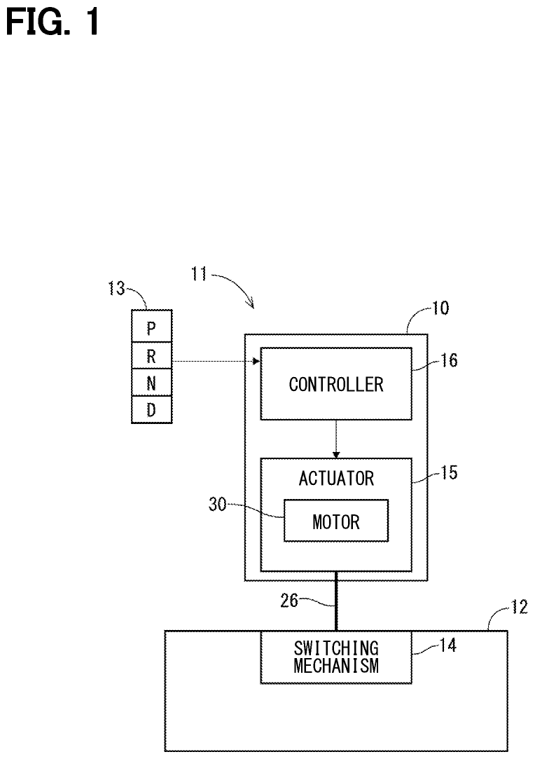

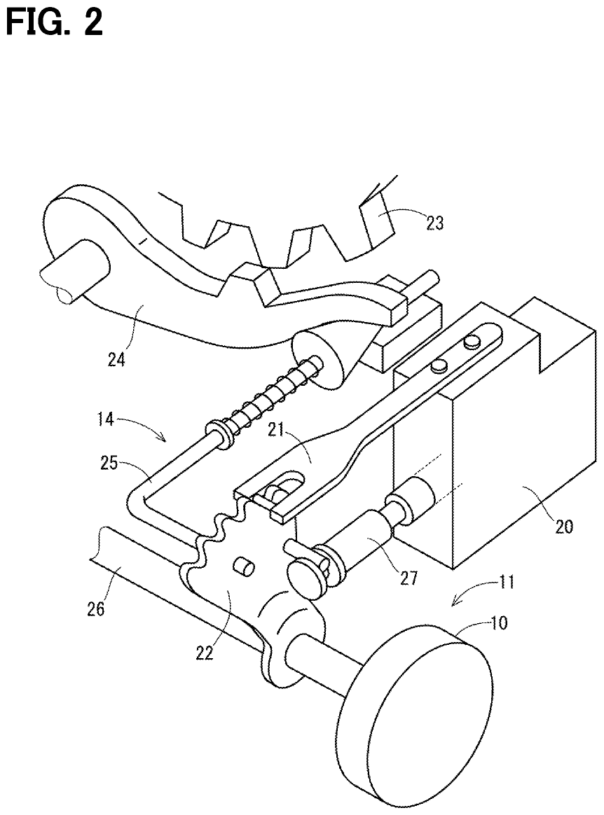

The configuration of the shift-by-wire system will be described with reference to FIGS. 1 and 2. As shown in FIG. 1, the shift-by-wire system 11 includes a shift operating device 13 that outputs an instruction (i.e., a command signal) to designate a shift range to the transmission 12 and an actuator 10 that operates a shift range switching mechanism 14 of the transmission 12. The actuator 10 includes an operating unit 15 that has a motor 30 and a controller 16 that controls the motor 30 in response to a shift range instruction signal.

As shown in FIG. 2, the shift range switching mechanism 14 includes a range switching valve 20, a detent spring 21 and a detent lever 22, a park pole 24, and a manual shaft 26. The range switching valve 20 controls a supply of hydraulic pressure to a hydraulic operating mechanism in the transmission 12 (see FIG. 1). The detent spring 21 and the detent lever 22 are configured to keep a shift range. The park rod 25 is configured to prevent an output shaft from rotating by fitting the park pole 24 into a park gear 23 of the output shaft of the transmission 12 when the shift range is switched to a parking range. The manual shaft 26 rotates together with the detent lever 22.

The shift range switching mechanism 14 rotates the detent lever 22 together with the manual shaft 26 to move a valve body 27 and the park rod 25 of the range switching valve 20 connected to the detent lever 22 to a position corresponding to a target shift range. In the shift-by-wire system 11, the actuator 10 is connected to the manual shaft 26 in order to perform the shift range change electrically.

### (Actuator)

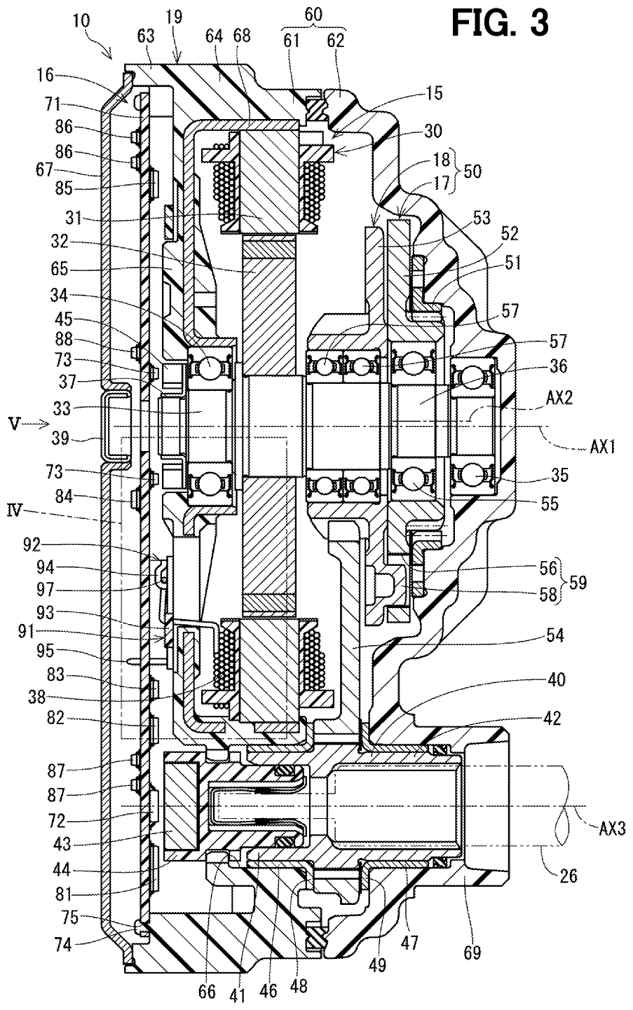

Next, the configuration of the actuator 10 will be described. As shown in FIG. 3, the actuator 10 is an electromechanical integrated actuator having the operating unit 15 and the controller 16 in a housing 19.

The housing 19 includes a plate cover 67 and a case 60 including a cylindrical upper case 61 and a cup-shaped lower case 62. A partition 65 is formed between one end 63 and the other end 64 of the upper case 61. A control board 71 is provided inside of the one end 63. The control board 71 is covered by a plate cover 67 provided at an opening of the one end 63, thereby ensuring shielding for the control board 71. The lower case portion 62 is attached to the other end portion 64. Further, the lower case portion 62 includes a cylindrical protruding portion 69 that protrudes toward a side opposite to the upper case 61. The manual shaft 26 is inserted into the cylindrical protrusion 69.

The operation unit 15 includes the motor 30 as a driving power generator, an output shaft 40 arranged in parallel with the motor 30, and a speed-reducing mechanism 50 that reduces a rotational speed of the motor 30 and transmits the rotation to the output shaft 40.

The motor 30 includes a stator 31 press-fitted into, and fixed to, a plate case 68 at the other end 64, a rotor 32 provided inside the stator 31, and a motor shaft 33 that rotates about a rotation axis AX1 together with the rotor 32. The motor shaft 33 is rotatably supported by both a bearing 34 disposed in the plate case 68 and a bearing 35 disposed in the lower case portion 62. Further, the motor shaft 33 has an eccentric portion 36 eccentric with the rotation axis AX1 at a position on a side of the rotor 32 close to the lower case portion 62. The motor 30 is able to rotate bidirectionally by controlling a current supplied to coils 38 by the controller 16 and is also able to stop at desired rotational positions. A plug 39 is attached to a through hole of the plate cover 67. If a failure occurs, the motor shaft 33 can be forcibly rotated manually after detaching the plug 39.

The speed-reducing mechanism 50 has a first speed-reducing portion 17 including a ring gear 51 and a sun gear 52 and a second speed-reducing portion 18 including a drive gear 53 and a driven gear 54 as parallel shafts type gears. The ring gear 51 is coaxially disposed with the rotation axis AX1. The sun gear 52 is rotatably supported about the eccentric axis AX2 by a bearing 55 that is fitted into the eccentric portion 36. The sun gear 52 meshes with, and fits snugly inside, the ring gear 51. When the motor shaft 33 rotates, the sun gear 52 performs planetary motion in which the sun gear 52 revolves around the rotation axis AX1 and rotates about the eccentric axis AX2. At this time, the rotational speed of the sun gear 52 is reduced relative to the rotational speed of the motor shaft 33. The sun gear 52 has a hole 56 for rotation transmission.

The drive gear 53 is provided on the rotation axis AX1 and is rotatably supported about the rotation axis AX1 by a bearing 57 fitted into the motor shaft 33. Further, the drive gear 53 has a protrusion 58 for rotation transmission that is inserted into the hole 56. The rotation of the sun gear 52 is transmitted to the drive gear 53 through engagement between the hole 56 and the protrusion 58. The hole 56 and the protrusion 58 constitute a transmission mechanism 59. The driven gear 54 is provided on the rotation axis AX3 which is parallel to the rotation axis AX1 and coaxial with the cylindrical protrusion 69. The driven gear 54 meshes with the drive gear 53 to circumscribe the drive gear 53. When the drive gear 53 rotates about the rotation axis AX1, the driven gear 54 rotates about the rotation axis AX3. At this time, the rotational speed of the driven gear 54 is reduced relative to the rotational speed of the drive gear 53.

The output shaft 40 has a cylindrical shape, and is provided coaxially with the rotation axis AX3. The partition 65 has a through supporting hole 66 coaxial with the rotation axis AX3. The output shaft 40 is rotatably supported about the rotation axis AX3 by a first flanged bush 46 fitted into the through supporting hole 66 and a second flanged bush 47 fitted inside the cylindrical protrusion 69. The driven gear 54 is a separate component from the output shaft 40, is fitted outwardly to the output shaft 40, and is connected to the output shaft 40 to transmit rotation. The manual shaft 26 is inserted into the output shaft 40, and is coupled to the output shaft 40 through, for example, spline fitting so as to transmit rotation.

One end 41 of the output shaft 40 is rotatably supported by the first flanged bush 46. The other end 42 of the output shaft 40 is rotatably supported by the second flanged bush 47. The driven gear 54 is supported in the axial direction by being clamped between a first flange portion 48 of the first flanged bush 46 and a second flange portion 49 of the second flanged bush 47. In another embodiment, the driven gear 54 may be supported in the axial direction by being clamped between a pair of supporting portions such as the case 60 and another plate.

The controller 16 includes a plurality of electronic components for controlling the motor 30, the control board 71 on which the electronic components are implemented, an output shaft position detection sensor 72 implemented on the control board 71, and a motor position detection sensor 73 implemented on the control board 71. The control board 71 has a plurality of outer circumferential fixing portions 75 fixed to the partition 65 by a heat caulking portion at an outer circumferential surface of the control board 71.

The plurality of electronic components include a microcomputer 81, a MOSFET 82, a capacitor 83, a diode 84, an ASIC 85, an inductor 86, a resistor 87, a capacitor chip 88, and the like.

The output shaft position detection sensor 72 is disposed on the control board 71 at a position facing the magnet 43. The magnet 43 is fixed to a holder 44 attached to the output shaft 40. The output shaft position detection sensor 72 detects a rotational position of the output shaft 40 and the manual shaft 26 rotating together with the output shaft 40 by detecting a magnetic flux generated by the magnet 43.

The motor position detection sensor 73 is disposed on the control board 71 at a position facing the magnet 45. The magnet 45 is fixed to a holder 37 attached to the motor shaft 33. The motor position detection sensor 73 detects a rotational position of the motor shaft 33 and the rotor 32 by detecting a magnetic flux generated by the magnet 45.

### (Connecting Structure)

Next, a configuration of a connecting portion between the motor 30 and the controller 16 will be described. Hereinafter, the radial direction of the motor 30 is simply referred to as a “radial direction”, the axial direction of the motor 30 is simply referred to as an “axial direction”, and the circumferential direction of the motor 30 is simply referred to as a “circumferential direction”.

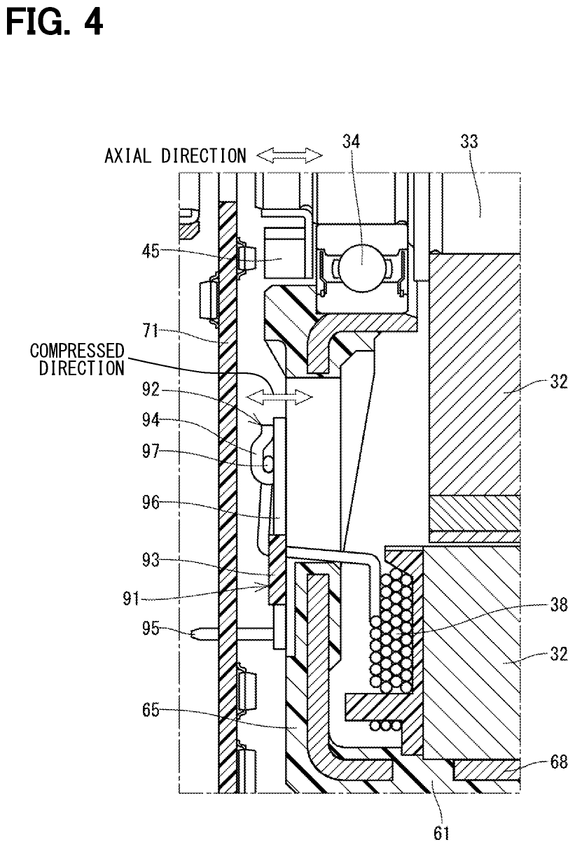

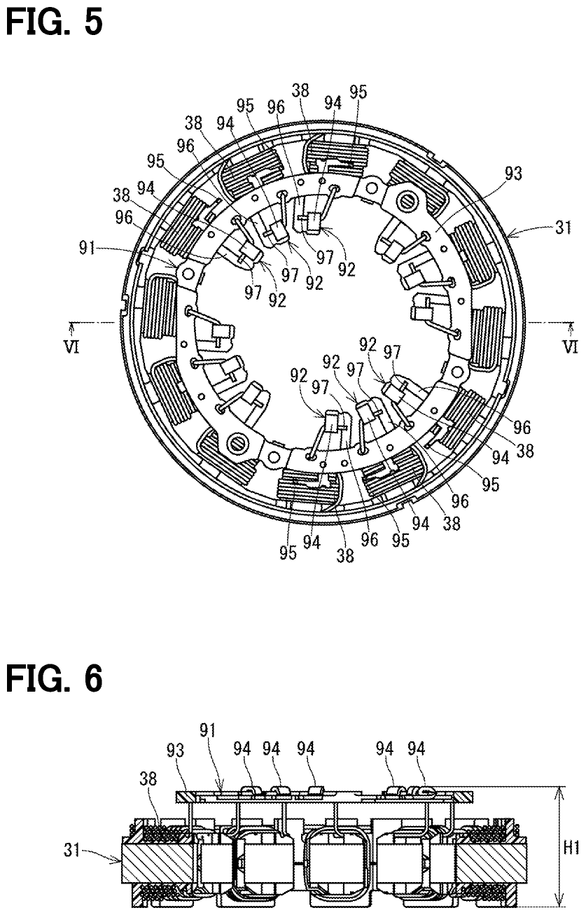

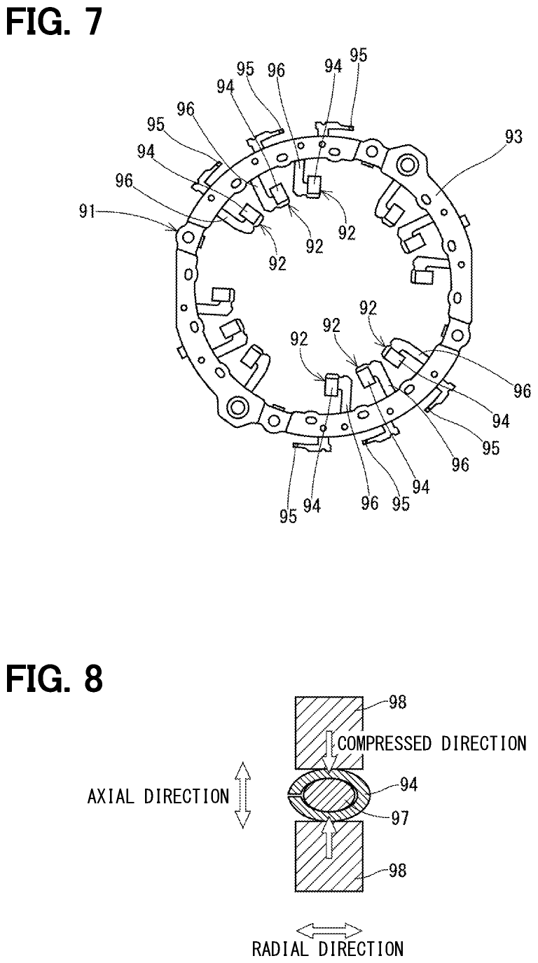

As shown in FIGS. 3 to 7, the actuator 10 includes a bus bar 91. The bus bar 91 includes a plurality of terminals 92 that electrically connect the coils 38 to the control board 71. The bus bar 91 also includes a resin holding member 93 that molds a part of each of the terminals 92.

The holding member 93 is a separate member from the housing 19, is formed in an annular shape, and is disposed concentric with the stator 31. The holding member 93 is fixed to a portion of the partition 65 of the upper case portion 61 that faces the control board 71 by, for example, heat swaging.

The terminals 92 are arranged in the circumferential direction of the bus bar 91. Each of the terminals 92 includes a fused portion 94, a pin portion 95, and an intermediate portion 96. The fused portion 94 is located radially inward of the holding member 93. The pin portion 95 is located radially outward of the holding member 93. The intermediate portion 96 connects the fused portion 94 and the pin portion 95. The pin portion 95 protrudes in the axial direction toward the control board 71, and is electrically connected to the control board 71 by, for example, soldering or snap fitting. The holding member 93 molds parts of the intermediate portions 96.

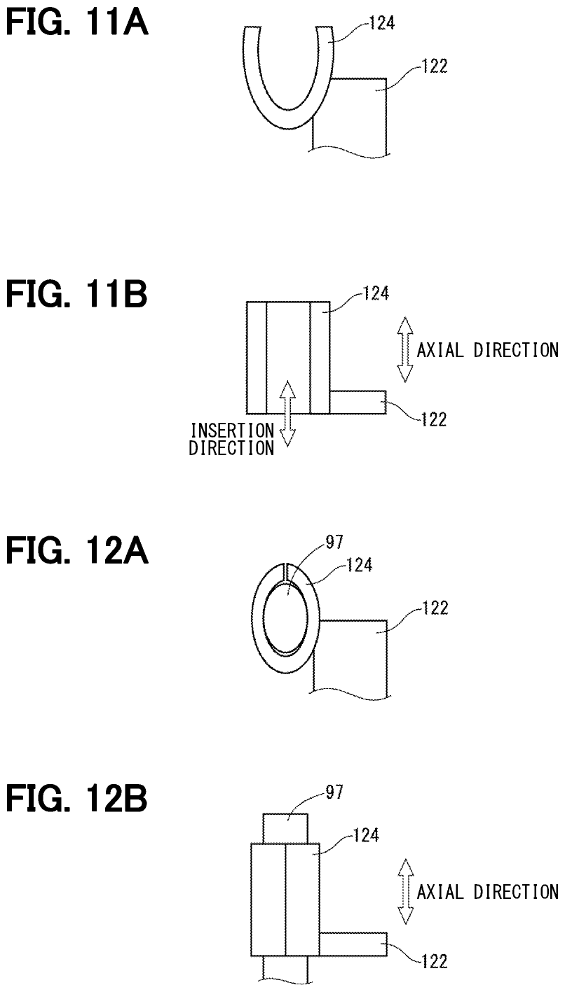

As shown in FIG. 8, the fused portion 94 is formed in a C-shape to sandwich an end 97 of the coil 38 (hereinafter, referred to as a “coil end”) in the axial direction. The coil end 97 is compressedly joined (welded) to the fused portion 94 by fusing (welding). The compressed direction of the fused portion 94 is in parallel with the axial direction. It should be noted, during a fusing step in a manufacturing process, the fused portion 94 is radially compressed while being heated by welding terminals 98 as shown in FIGS. 12 A and 12B, and the fused portion 94 and the coil end 97 are electrically connected via fusing (welding).

As described above, in the first embodiment, the terminal 92 has the fused portion 94 that is electrically connected to the coil 38. The compressed direction of the fused portion 94 is aligned with the axial direction of the motor 30. In this way, by setting the compressed direction of the fused portion 94 to be in parallel with (or aligned with) the axial direction of the motor 30, the total thickness H1 along the axial direction (see FIG. 6) of the stator 31 and the fused portions 31 can be reduced by the compressed amount of the fused portions 94 in the axial direction by fusing. Therefore, the size of the actuator 10 can be reduced in the axial direction by arranging the control board 71, for example, adjacent to the fused portions 94 in a position close to the motor 30.

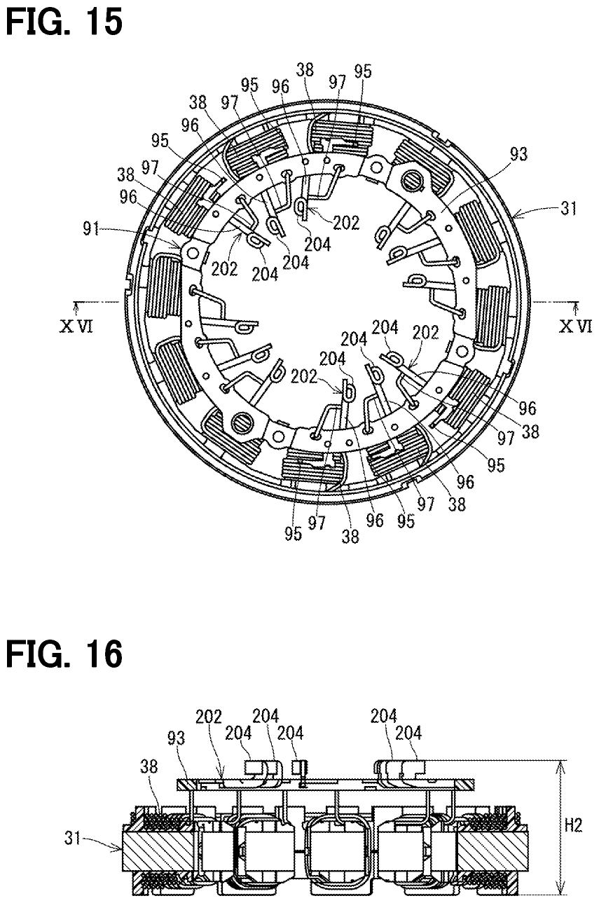

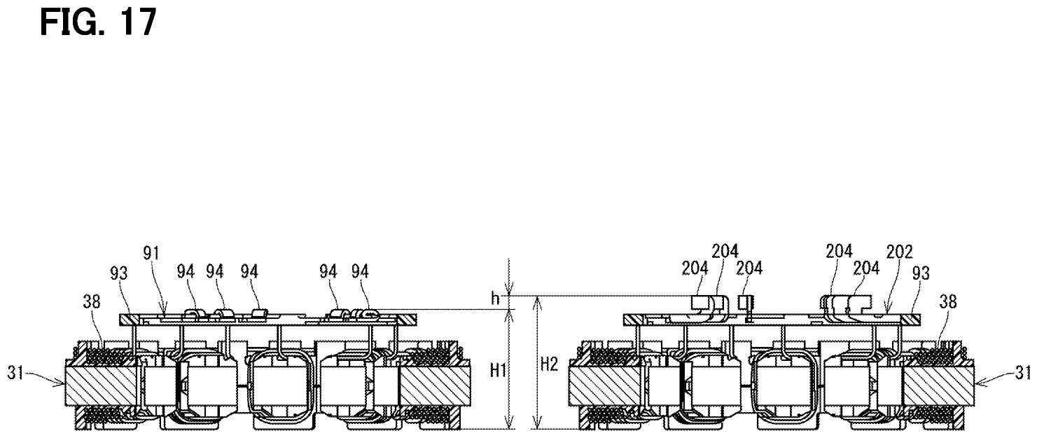

Here, advantages of the first embodiment will be described by comparison with a comparative example illustrated in FIGS. 15 and 16. In the comparative example, the compressed direction of the fused portion 204 of each of the terminals 202 is a direction perpendicular to the axial direction of the motor. In this comparative example, each of the fused portions 204 is not deformed in the axial direction through fusing, and thus the total thickness H2 along the axial direction (see FIG. 16) of the stator 31 and the fused portions 204 is not reduced. On the contrary, in the first embodiment as shown in FIG. 17, the thickness H1 of the motor 30 is less than that of the comparative example by the compressed amount h by which the fused portion 94 is deformed (compressed) in the axial direction by fusing.

In the first embodiment, the terminals 92 are formed integrally with the holding member 93 which is a separate member from the housing 19. As a result, the plurality of terminals 92 are brought together so that the terminals can be easily assembled (handled), and the size of the motor 30 in the axial direction can be reduced by being integrated into a single component as the bus bar 91.

### Second Embodiment

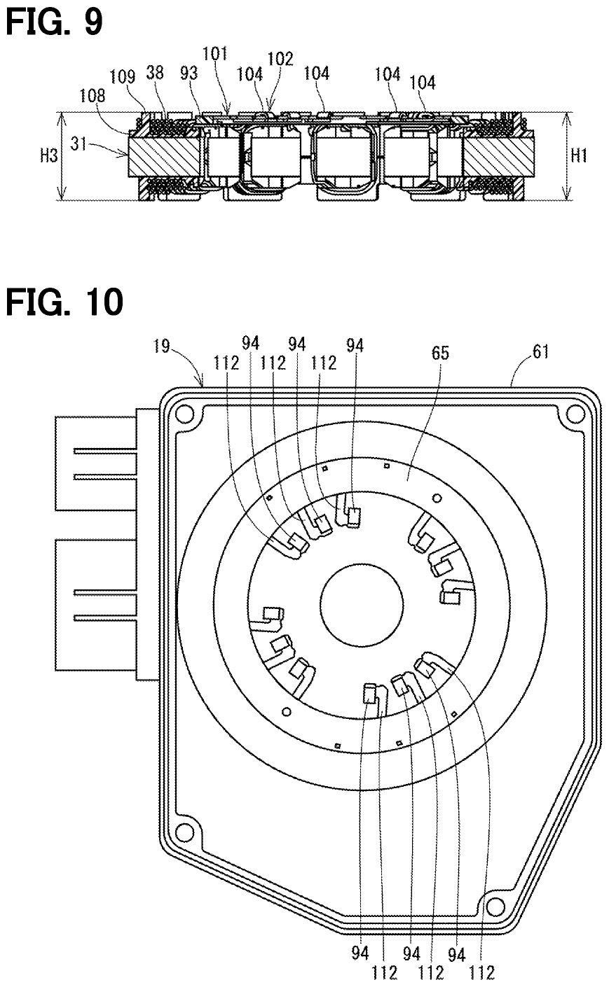

In the second embodiment, the stator 31 includes a portion (hereinafter, a maximum thickness portion) having a maximum thickness in the axial direction, and the fused portions 104 of the terminals 102 of the bus bar 101 are positioned radially inward of the maximum thickness portion of the stator 31 as shown in FIG. 9. In this embodiment, the maximum thickness portion is a protrusion 109 of a bobbin 108 that holds the coils 38 at positions radially outward of the coils 38. The protrusion 109 protrudes in the axial direction from one surface of the stator 31. The fused portions 104 are disposed on the one surface. The fused portions 104 are configured not to protrude beyond the protrusion 109 in the axial direction. Because of this, the thickness H1 in the axial direction between the other surface of the stator 31, which is opposite to the one surface, and the fused portions 104 can be equal to or less than the thickness H3 of the maximum thickness portion 109 in the axial direction. Therefore, the size of the actuator 10 can be reduced in the axial direction by arranging the control board, for example, adjacent to the fused portions 104 in a position close to the motor.

In particular, in the second embodiment, the fused portions 104 are arranged not to protrude beyond the maximum thickness portion 109 in the axial direction. Thus, even though the fused portions 104 are arranged one the one surface of the stator 31, and thus completely overlap with the stator 31 in the axial direction, the thickness H1 can still be less than the thickness H3 of the maximum thickness portion 109.

### Third Embodiment

In the third embodiment, the terminals 112 are integrally formed with the housing 19 as shown in FIG. 10. Specifically, the terminals 112 are insert-molded with the partition 65 of the upper case 61. As a result, the plurality of terminals 112 are brought together so that the terminals can be easily assembled (handled), and the size of the motor 30 in the axial direction can be reduced by being integrated into a single component as the housing 19.

### Fourth Embodiment

In the fourth embodiment, a method for manufacturing the actuator 10 will be described with reference to FIGS. 11A to 14B. The method includes a fusing step and a bending step. Prior to the fusing step, the fused portion 124 of the terminal 122 is formed such that the insertion direction for the coil end 97 is in parallel with the axial direction as shown in FIGS. 11A and 11B. In other words, the insertion hole of the fused portion 124 for the coil 3nd 97 is open in a direction in parallel with the axial direction.

In the fusing step, fusing (welding) is performed to electrically connect the fused portion 124 to the coil end 97 by compressing and heating the fused portion 124 of the terminal 122 in a direction perpendicular to (i.e., intersecting) the axial direction as shown in FIGS. 12A and 12B.

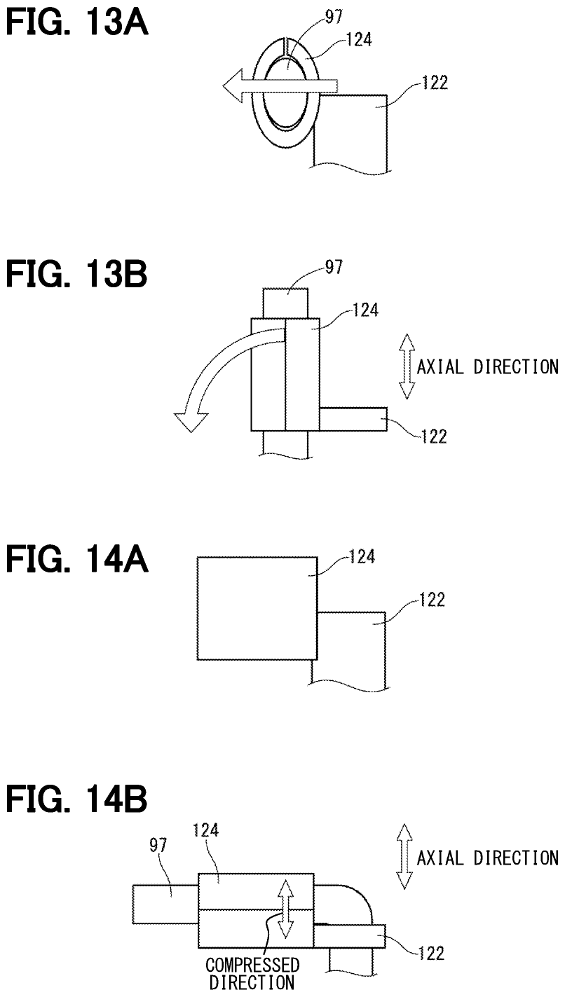

Then, in the bending step, the terminal 122 is bent together with the fused portion 124 at a specified portion of the terminal 122 (i.e., a connecting portion between the fused portion 124 and the intermediate portion 96) as shown in FIGS. 13A and 13B so that the compressed direction of the fused portion 124 is shifted (rotated) to be in parallel with the axial direction as shown in FIGS. 14A and 14B.

As described above, by bending the fused portion 94 after the fused portion 124 is compressedly joined to the coil end 97 in the direction perpendicular to the axial direction, the process of manufacturing the actuator 10 can be easily performed.

### Other Embodiments

In another embodiment, the fused portion may be positioned radially outward of the portion of the stator having the maximum thickness. In another embodiment, the bus bar is not limited to one holding member, and may have a plurality of holding members. In yet another embodiment, the control substrate may be fixed not only by heat caulking but also by another fixing measure such as screw fastening, bonding, press-fitting, and press-fitting. Further, the control substrate is not necessarily limited to be fixed to the case, and may be fixed to a plate cover which is another part of the housing.

The present disclosure is not limited to the embodiments described above, and can be implemented in various forms without departing from the spirit of the invention.

1. A rotary actuator used in a shift-by-wire system for a vehicle, the actuator comprising:
a motor;
a controller that controls the motor;
a housing that holds a stator of the motor and the controller; and
a terminal that electrically connects a coil of the stator to the controller, wherein
the terminal includes a fused portion electrically connected to the coil, and
the fused portion is compressed in a direction in parallel with an axial direction of the motor.

2. The rotary actuator according to claim 1, wherein
the stator includes a portion having a maximum thickness in the axial direction, and
the fused portion is disposed radially inward or outward of the portion of the stator.

3. The rotary actuator according to claim 2, wherein
the terminal is integrally formed with a holding member that is a separate member from the housing.

4. The rotary actuator according to claim 1, wherein
the terminal is integrally formed with the housing.

5. A method for manufacturing a rotary actuator that is used in a shift-by-wire system for a vehicle, the rotary actuator including: a motor; a controller that controls the motor; a housing that houses a stator of the motor and the controller; and a terminal that electrically connects a coil of the stator to the controller, the method comprising:
electrically connecting a fused portion of the terminal to the coil by compressing the fused portion in a compressed direction while heating the fused portion; and
bending the terminal together with the fused portion so that the compressed direction of the fused portion is shifted to be in parallel with the axial direction of the motor.
